(19) United States
(12) Patent Application Publication
(10) Pub. No.: US 2025/0258285 A1
(43) Pub. Date: Aug. 14, 2025

(54) Transducer Assembly and Ultrasonic Sensor with Absorbing Element

(71) Applicant: TE Connectivity Solutions GmbH, Schaffhausen (CH)

(72) Inventors: Jessica H. B. Hemond, Middletown, PA (US); Michael Pedrick, Hampton, VA (US); Ye Wang, Middletown, PA (US)

(73) Assignee: TE Connectivity Solutions GmbH, Schaffhausen (CH)

(21) Appl. No.: 18/437,329

(22) Filed: Feb. 9, 2024

(51) Int. Cl. G01S 7/521; B06B 1/06; G10K 11/00

(52) U.S. Cl. CPC G01S 7/521; B06B 1/0644; G10K 11/004

(57) ABSTRACT

A transducer assembly includes a transducer emitting or receiving an ultrasonic wave and a backing adjacent to the transducer. The backing is an absorbing element that provides acoustic damping for the transducer. The backing is formed of a base material with a bio-based additive dispersed within the base material.

### FIELD OF THE INVENTION

The present invention relates to an ultrasonic sensor and, more particularly, to an absorbing element of the ultrasonic sensor.

### BACKGROUND

An ultrasonic sensor includes a housing having an emitter and a receiver disposed in the housing. The emitter is controlled to emit an ultrasonic wave through the housing that is received by the receiver and output as a voltage signal. When external elements, such as a tube having a fluid, are positioned between the emitter and the receiver, the ultrasonic sensor can be used to detect qualities of the external element by analyzing the voltage signal that depends on the ultrasonic wave received by the receiver.

Acoustic absorbing materials can be used to improve the performance of the ultrasonic sensor by damping portions of the ultrasonic wave. The acoustic absorbing material is commonly an epoxy that is mixed with a tungsten powder. The epoxy and tungsten mixture is wet potted into the housing around the emitter and receiver and cured in the housing to provide the acoustic absorption. This assembly process, however, is difficult and time consuming. Further, the tungsten can settle within the epoxy, which can increase electrical conductivity at surfaces of the epoxy and cause unwanted signal attenuation.

### SUMMARY

A transducer assembly includes a transducer emitting or receiving an ultrasonic wave and a backing adjacent to the transducer. The backing is an absorbing element that provides acoustic damping for the transducer. The backing is formed of a base material with a bio-based additive dispersed within the base material.

### BRIEF DESCRIPTION OF THE DRAWINGS

The invention will now be described by way of example with reference to the accompanying Figures, of which:

FIG. 1 is an exploded perspective view of an ultrasonic sensor according to an embodiment;

FIG. 2A is a schematic sectional side view of the ultrasonic sensor of FIG. 1;

FIG. 2B is a detail view of a portion 2B of FIG. 2A;

FIG. 3 is a top view of the ultrasonic sensor of FIG. 1;

FIG. 4 is a schematic perspective view of a printer printing a backing according to an embodiment; and

FIG. 5 is a graph of relative attenuation versus the volume fraction of a bio-based additive in an absorbing element according to an embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details. Throughout the drawings, only one of a plurality of identical elements may be labeled in a figure for clarity of the drawings, but the detailed description of the element herein applies equally to each of the identically appearing elements in the figure.

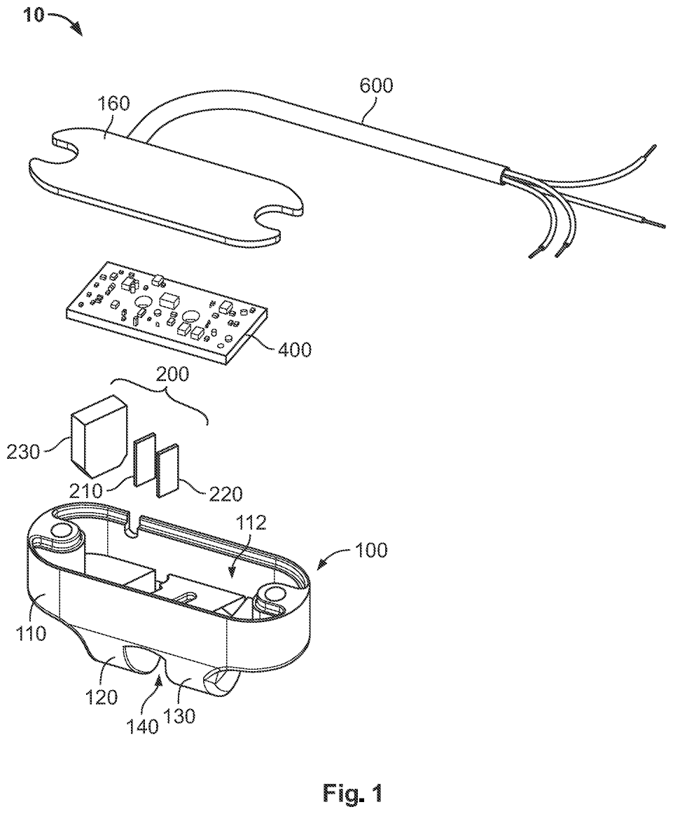

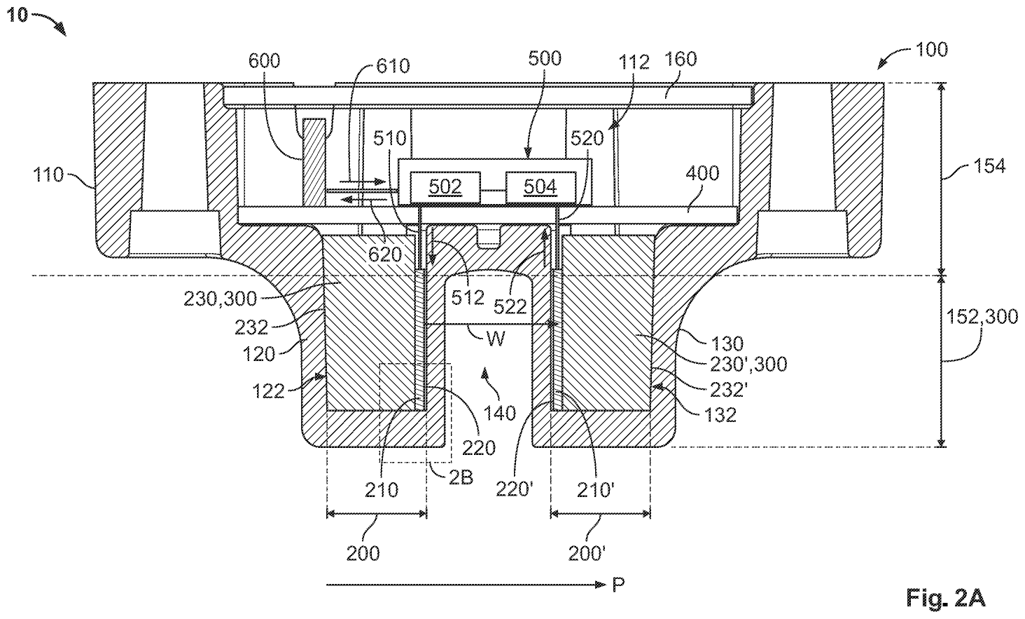

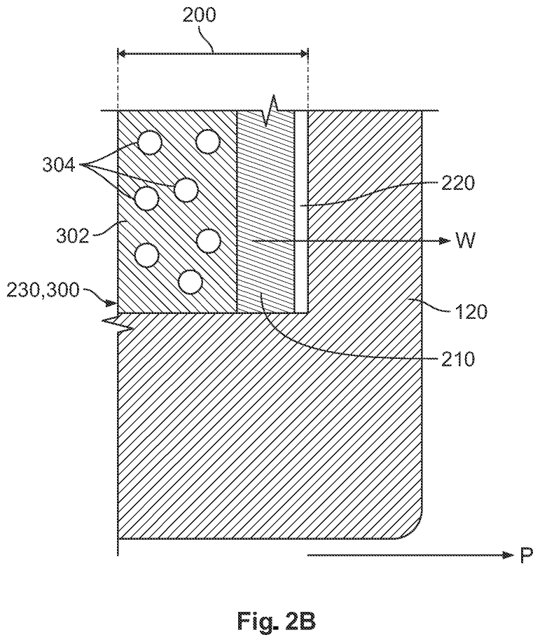

An ultrasonic sensor 10 according to an embodiment, as shown in FIGS. 1 and 2A, includes a housing 100 and a pair of transducer assemblies 200, 200′ positioned in the housing 100. Only a first transducer assembly 200 is visible in FIG. 1; a second transducer assembly 200′ is positioned within the housing 100 in the view of FIG. 1.

The housing 100, as shown in FIGS. 1 and 2A, has a body 110, a first protrusion 120 extending from the body 110, and a second protrusion 130 extending from the body 110. The housing 100 has a channel 140 defined between the first protrusion 120 and the second protrusion 130. The channel 140 is positioned between the first protrusion 120 and the second protrusion 130 along a propagating direction P shown in FIG. 2A and described in greater detail below.

The body 110 defines a housing receiving space 112 at an interior of the housing 100. As shown in FIG. 2A, the first protrusion 120 defines a first receiving portion 122 within the first protrusion 120 that is connected to the housing receiving space 112. The second protrusion 130 defines a second receiving portion 132 within the second protrusion 130 that is connected to the housing receiving space 112.

The housing 100, including the body 110 and the protrusions 120, 130, may be monolithically formed in a single piece from a housing material. In an embodiment, and as described in greater detail below, the housing 100 may be formed by additive manufacturing, for example by vat polymerization with the housing material as a photopolymer resin that is curable by light irradiation. In other embodiments, the housing 100 may be formed of any material used in ultrasonic applications and by any process that is capable of forming the components of the housing 100 described herein.

In the embodiment shown in FIGS. 1 and 2A, the housing 100 has a cover 160. The cover 160 may be formed of a same material as the body 110 and the protrusions 120, 130, but is formed separately from the body 110 and the protrusions 120, 130.

The transducer assemblies 200, 200′ each have a transducer 210, 210′, a securing element 220, 220′ attached to the transducer 210, 210′, and a backing 230, 230′ disposed on a side of the transducer 210, 210′ opposite the securing element 220, 220′ in the propagating direction P, as shown in FIGS. 1, 2A, and 2B. The components of the first transducer assembly 200 and the second transducer assembly 200′ are identical and, throughout the description, the same description applies to the same reference numbers used for both transducer assemblies 200, 200′. The components of the second transducer assembly 200′ have reference numbers with added apostrophes only for clarity in differentiating between the two transducer assemblies 200, 200′.

The transducer 210, 210′ of each of the transducer assemblies 200, 200′, in the shown embodiment, is a piezoelectric crystal. In the shown embodiment, the transducer assembly 200 is an emitter, and the transducer 210 is capable of being electrically excited at its resonant frequency with an input voltage to emit an ultrasonic wave W. The transducer 210 can be any type of transducer that is capable of producing the ultrasonic wave W as described herein. The transducer assembly 200′ is a receiver in the shown embodiment, and the transducer 210′ is capable of receiving the ultrasonic wave W from the transducer 210 and producing an output voltage based on the received ultrasonic wave W. In other embodiments, the transducer assembly 200 is the receiver and the transducer assembly 200′ is the emitter.

The securing element 220, 220′ of each of the transducer assemblies 200, 200′, shown in FIGS. 2A and 2B, may be any type of element or material that is capable of securing the transducers 210, 210′ to the housing material of the housing 100. In various exemplary embodiments, the securing element 220, 220′ may be an adhesive, such as epoxy, acrylic, or polyurethane, and secures by adhesive attachment. In other embodiments, the securing element 220, 220′ may be a conformal material or a viscous gel that secures by friction generated through compression.

The backing 230, 230′ of each of the transducer assemblies 200, 200, shown in FIGS. 1, 2A, and 2B, is an absorbing element 300 that provides acoustic damping for the transducer 210, 210′. In the embodiment of FIGS. 1, 2A, and 2B, the backing 230, 230′ acting as the absorbing element 300 is formed of a base material 302 with a bio-based additive 304 dispersed within the base material 302, as shown schematically in FIG. 2B.

The base material 302 is a polymer, such as a polyacrylate. In the embodiment described below in which the backing 230, 230′ of each of the transducer assemblies 200, 200 is formed by additive manufacturing, the base material 302 is a photopolymer resin that is curable by light irradiation.

The bio-based additive 304 is a biological or naturally occurring element that, when dispersed in the base material 302 and formed into the backing 230, 230′, enhances the acoustic damping for the transducer 210, 210′ as described in greater detail below. In an embodiment, the bio-based additive 304 is cellulose. In other embodiments, the bio-based additive 304 may be wood flour, rice hulls, ground shells, or any other biological elements that can provide the damping function described herein. The bio-based additive 304, in an embodiment, is at least 10% of the backing 230, 230′ by volume and is less than or equal to 30% of the backing 230, 230′ by volume.

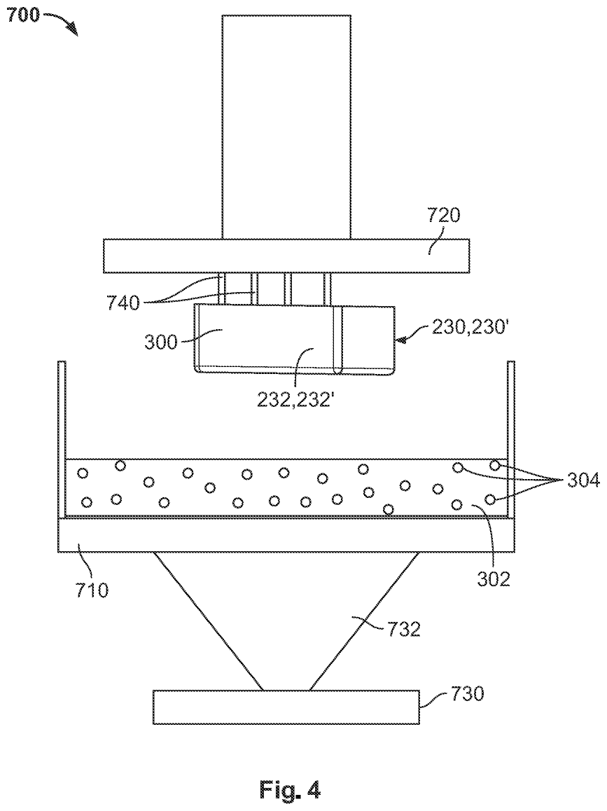

The formation of the backing 230, 230′ by additive manufacturing using a printer 700 is shown schematically in FIG. 4. The printer 700 produces products by additive manufacturing, and in the shown embodiment is a vat photopolymerization printer. The printer 700 includes a vat 710 that contains the base material 302 in a liquid state mixed with the bio-based additive 304. A plate 720 is movable into and out of the liquid contained in the vat 710, and a light source 730 can selectively expose light 732 on various areas of the base material 302 and bio-based additive 304 mixture contained in the vat 710. In this embodiment, the base material 302 is a photopolymer resin that is curable from the liquid state to a cured state by the light 732 irradiated by the light source 730. The printer 700 may operate by stereolithography (SLA), digital light processing (DLP), continuous digital light processing (CDLP), or any other type of three-dimensional printing process that creates a product by sequentially curing a plurality of layers of a liquid material. In an embodiment, the base material 302 may require secondary curing of additional light irradiation and/or heat.

The printer 700 moves the plate 720 into and out of the vat 710 to progressively cure a series of layers of the base material 302 mixed with the bio-based additive 304. The layers are attached to the plate 720 by a plurality of supports 740. The layers are cured on top of one another until the backing 230, 230′ serving as the absorbing element 300 is fully formed monolithically as schematically shown in FIG. 4. The printer 700 shown in FIG. 4 is merely one exemplary embodiment of the printer 700; the printer 700 may be of any type capable of forming the absorbing element 300 as described herein.

The assembly of the transducer assemblies 200, 200′ in the housing 100 will now be described in greater detail primarily with reference to FIGS. 1-3.

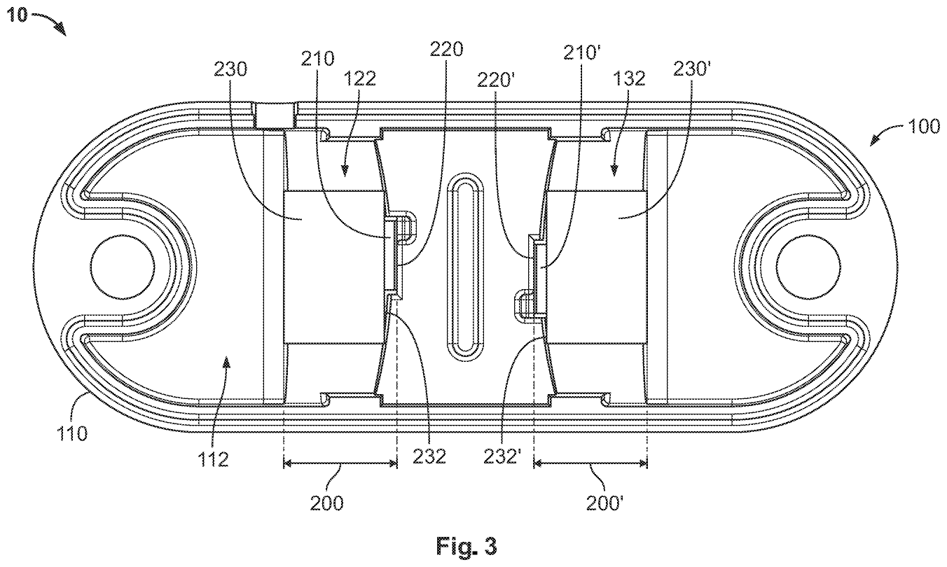

The transducer assemblies 200, 200′ are each positioned in one of the receiving portions 122, 132 of the housing 100, as shown in FIGS. 2A, 2B, and 3. The first transducer assembly 200 is positioned in the first receiving portion 122 of the first protrusion 120 and the second transducer assembly 200′ is positioned in the second receiving portion 132 of the second protrusion 130.

As shown in FIGS. 2A and 2B, the securing element 220 is positioned between the transducer 210 of the first transducer assembly 200 and the first protrusion 120, and the securing element 220′ is positioned between the transducer 210′ of the second transducer assembly 200′ and the second protrusion 130. The securing element 220, 220′ secures the transducer 210, 210′ to the respective protrusion 120, 130 of the housing 100. In an embodiment in which the securing element 220, 220′ is an adhesive, the securing element 220, 220′ attaches the transducer 210, 210′ to the housing 100. In an embodiment in which the securing element 220, 220′ is a compressive element, the securing element 220, 220′ is compressed between the transducer 210, 210′ and the housing 100 and secures the transducer 210, 210′ by friction.

As shown in FIG. 2A, the securing element 220 secures the transducer 210 of the first transducer assembly 200 in the first receiving portion 122 of the first protrusion 120 and facing along the propagating direction P toward the channel 140. The securing element 220′ secures the transducer 210′ of the second transducer assembly 200′ in the second receiving portion 132 of the second protrusion 130 and facing opposite to the propagating direction P, facing the channel 140 and the transducer 210 of the first transducer assembly 200.

The backing 230, 230′ formed as the absorbing element 300 is inserted into the receiving portion 122, 132 of each of the protrusions 120, 130 adjacent to one of the transducers 210, 210′, as shown in FIGS. 2A, 2B, and 3. Printing the backing 230, 230′ by additive manufacturing allows for precise control of an outer shape 232, 232′ and dimensions of the backing 230, 230′. As shown schematically in FIGS. 2A and 3, the size and outer shape 232, 232′ of the backing 230, 230′ can be adapted to fit precisely in the receiving portions 122, 132; the backing 230, 230′ is printed with the outer shape 232, 232′ that corresponds to a space between the transducer 210, 210′ and the housing 100, and is adaptable to the particular shape of and size of the receiving portions 122, 132 of the housing 100. The backing 230, 230′ is dimensioned to have the transducer assembly 200, 200′ fill the respective receiving portion 122, 132. The transducer 210, 210′ of each of the transducer assemblies 200, 200′ is positioned between the backing 230, 230′ and the securing element 220, 220′. The backing 230, 230′ abuts the transducer 210, 210′ and forms an interference fit between the transducer 210, 210′ and the housing 100.

An assembly of a remainder of the ultrasonic sensor 10 shown in FIGS. 1 and 2A and the operation of the ultrasonic sensor 10 will now be described in greater detail.

The ultrasonic sensor 10 includes a printed circuit board (PCB) 400 that has a controller 500 and is connected to a connection line 600, as shown schematically in FIGS. 1 and 2A. The controller 500 includes a processor 502 and a memory 504 connected to the processor 510. The memory 504 is a non-transitory computer readable medium capable of storing program instructions thereon that are executable by the processor 502. The processor 502 executes programs stored on the memory 504 to perform the functions of the controller 500 described herein.

As shown in FIG. 2A, the PCB 400 with the controller 500 is positioned in the housing receiving space 112 of the body 110. The cover 160 is positioned to enclose the housing receiving space 112 with a space for the connection line 600 to extend from the PCB 400 to an area external of the housing 100. In the shown embodiment, the controller 500 receives power from a supply voltage 610 transmitted along the connection line 600.

The controller 500, as shown in FIG. 2A, has an emitter connection line 510 connecting the controller 500 to the transducer 210 of the transducer assembly 200 that serves as the emitter, along which the controller 500, by execution of the processor 502, can transmit an input signal 512 to the transducer 210. The controller 500 has a receiver connection line 520 connecting the controller 500 to the transducer 210′ of the transducer assembly 200′ that serves as the receiver, along which the controller 500, by execution of the processor 502, can receive an output signal 522 from the transducer 210′.

During operation of the ultrasonic sensor 10, the controller 500 outputs the input signal 512 to the transducer 210 along the emitter connection line 510. The transducer 210 produces the ultrasonic wave W in accordance with the input signal 512, which is emitted out from the transducer 210 in the propagation direction P toward the channel 140. The ultrasonic wave W is received by the transducer 210′ after it passes through the channel 140, and the transducer 210′ outputs the output signal 522 depending on the ultrasonic wave W along the receiver connection line 520 back to the controller 500.

The ultrasonic wave W received at the transducer 210′ is impacted by refraction through elements positioned in the channel 140. The controller 500 analyzes the output signal 522 to determine changes in the elements positioned in the channel 140, which can be used for various detection applications. For example, if a fluid conduit is positioned in the channel 140, the controller 500 can analyze the output signal 522 to determine a presence or an absence of a bubble in fluid that is transmitted along the fluid conduit. The controller 500 can output the results of the analysis of the output signal 522 via a signal voltage 620 transmitted along the connection line 600.

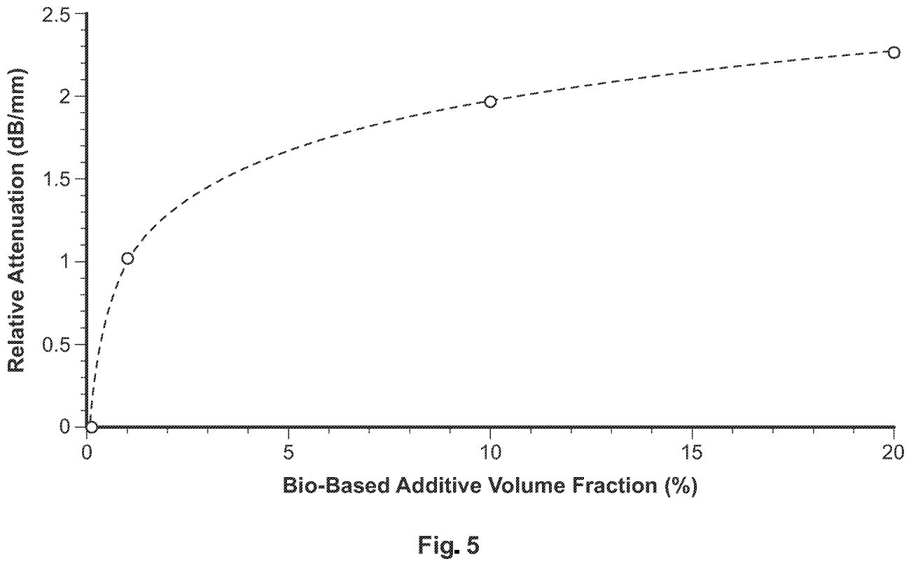

The positioning of the backing 230, 230′ acting as the absorbing element 300 adjacent to each of the transducers 210, 210′ provides acoustic damping for the transducers 210, 210′, which improves the performance of the ultrasonic sensor 10 by increasing the bandwidth and decreasing ringing associated with the ultrasonic wave W. As shown in FIG. 5, using different quantities of the bio-based additive 304 in the absorbing element 300 provides varying ultrasonic attenuation that improves the performance of the ultrasonic sensor 10. The bio-based additive 304 included as at least 10% of the backing 230, 230′ by volume provides at least approximately 2 dB/mm of relative attenuation for the ultrasonic wave W.

In another embodiment, additional and/or alternative parts of the ultrasonic sensor 10 may be formed of the absorbing element 300 having the base material 302 with the bio-based additive 304 dispersed within the base material 302.

As shown in FIG. 2A, in an embodiment, the housing 100 has a first section 152 and a second section 154 formed monolithically with the first section 152. The first section 152 extends along the first protrusion 120 and the second protrusion 130, and the second section 154 forms the body 110 of the housing 100. In this embodiment, the first section 152 of the housing 100 is formed as the absorbing element 300; the housing material is the base material 302 and the bio-based additive 304 is dispersed within the base material 302 of the housing 100 in the first section 152. In this embodiment, the second section 154 of the housing 100 does not have the bio-based additive 304 and is not formed as the absorbing element 300.

The housing 100 in the embodiment with the first section 152 and the second section 154 may be formed by additive manufacturing, using the printer 700 as described above with respect to FIG. 4. In this embodiment, the second section 154 is printed first with only the base material 302 in the vat 710, then the base material 302 is mixed with the bio-based additive 304 prior to printing the remaining layers of the first section 152 on the second section 154.

The first section 152 of the housing 100 formed as the absorbing element 300 provides attenuation and acoustic damping benefits as described above with respect to the backing 230, 230′. As shown in FIG. 2A, the first section 152 of the housing 100 can be formed as the absorbing element 300 with the bio-based additive 304 and the backing 230, 230′ of the transducer assemblies 200, 200′ can also be formed as the absorbing element 300 with the bio-based additive 304 in the same embodiment. In another embodiment, the housing 100 is formed of only one material and does not have the first section 152 formed as the absorbing element 300; in this embodiment, the backing 230, 230′ is the only absorbing element 300. In a further embodiment, the first section 152 of the housing 100 is the only absorbing element 300; in this embodiment, the backing 230, 230′ is formed as another type of acoustic damping material, such as foam, an epoxy filled with a tungsten powder, or any other type of acoustic damping material that provides damping for ultrasonic applications.

In the embodiments of the ultrasonic sensor 10 described above, the absorbing element 300, formed as the backing 230, 230′ and/or the first section 152 of the housing 100, provides acoustic damping that improves the emission and reception of the ultrasonic wave W by the transducers 210, 210′, which improves the accuracy and reliability of the ultrasonic sensor 10. Forming the absorbing element 300 by additive manufacturing allows for easier positioning of the transducers 210, 210′ adjacent to the absorbing element 300. The backing 230, 230′ formed as the absorbing element 300 by additive manufacturing further allows for precise fitting of the backing 230, 230′ into spaces of the housing 100 that may require complex shapes.

What is claimed is:

1. A transducer assembly, comprising:
a transducer emitting or receiving an ultrasonic wave; and
a backing adjacent to the transducer, the backing is an absorbing element that provides acoustic damping for the transducer, the backing is formed of a base material with a bio-based additive dispersed within the base material.

2. The transducer assembly of claim 1, wherein the backing abuts the transducer.

3. The transducer assembly of claim 1, wherein the bio-based additive is cellulose.

4. The transducer assembly of claim 1, wherein the bio-based additive is at least 10% of the backing by volume.

5. The transducer assembly of claim 4, wherein the bio-based additive is less than or equal to 30% of the backing by volume.

6. The transducer assembly of claim 1, further comprising a securing element, the transducer is positioned between the backing and the securing element.

7. The transducer assembly of claim 1, wherein the transducer is a piezoelectric crystal.

8. An ultrasonic sensor, comprising:
a housing; and
a transducer assembly positioned in the housing, the transducer assembly includes a transducer and a backing adjacent to the transducer, the backing and/or a portion of the housing is an absorbing element that provides acoustic damping for the transducer, the absorbing element is formed of a base material with a bio-based additive dispersed within the base material.

9. The ultrasonic sensor of claim 8, wherein the transducer assembly includes a securing element positioned between the transducer and the housing, the securing element secures the transducer to the housing.

10. The ultrasonic sensor of claim 8, wherein the housing has a body, a first protrusion extending from the body, a second protrusion extending from the body, and a channel positioned between the first protrusion and the second protrusion.

11. The ultrasonic sensor of claim 10, wherein the transducer assembly is one of a pair of transducer assemblies, one of the transducer assemblies is positioned in a first receiving portion of the first protrusion and the other of the transducer assemblies is positioned in a second receiving portion of the second protrusion.

12. The ultrasonic sensor of claim 10, wherein the housing has a first section and a second section formed monolithically with the first section, the first section is the only portion of the housing formed as the absorbing element.

13. The ultrasonic sensor of claim 12, wherein the first section extends along the first protrusion and the second protrusion.

14. A process for manufacturing an ultrasonic sensor, comprising:
printing an absorbing element by additive manufacturing; and
positioning the absorbing element adjacent to a transducer that emits an ultrasonic wave, the absorbing element provides acoustic damping for the transducer.

15. The process of claim 14, wherein the absorbing element is printed of a base material with a bio-based additive dispersed within the base material.

16. The process of claim 15, wherein the base material is a photopolymer resin that is curable by light irradiation.

17. The process of claim 14, wherein the absorbing element is a portion of a housing, the positioning step includes inserting the transducer into the housing.

18. The process of claim 14, wherein the absorbing element is a backing that is inserted into a housing adjacent to the transducer.

19. The process of claim 18, wherein the backing is interference fit between the transducer and the housing.

20. The process of claim 18, wherein the backing is printed with an outer shape corresponding to a space between the transducer and the housing.
